(19) United States
(12) Patent Application Publication
(10) Pub. No.: US 2026/0298648 A1
(43) Pub. Date: Oct. 1, 2026

(54) INFORMATION MANAGEMENT SYSTEM AND INFORMATION MANAGEMENT METHOD

(71) Applicant: Hitachi, Ltd., Tokyo (JP)

(72) Inventors: Yosuke AKISHITA, Tokyo (JP); Anjali RAJITH, Tokyo (JP); Soki SAKURAI, Tokyo (JP); Koji URAWAKI, Tokyo (JP); Mitsuhiro KITANI, Tokyo (JP); Kosuke OSHIMA, Tokyo (JP)

(73) Assignee: Hitachi, Ltd., Tokyo (JP)

(21) Appl. No.: 18/881,962

(22) PCT Filed: Feb. 17, 2023
(86) PCT No.: PCT/JP2023/005727

§ 371 Date: Jan. 7, 2025

(30) Foreign Application Priority Data
Aug. 10, 2022 (JP) 2022-128178

(51) Int. Cl. G01C 21/34

(52) U.S. Cl. CPC G01C 21/3469

(57) ABSTRACT

An information management system that extracts an asset usable by a consignor from use status data that are used for delivering a cargo by an electric vehicle, based on the use status data and a delivery specification of cargo to be delivered, reads, for an asset owner of the extracted usable asset, an evaluation index of a concern important to the consignor when making a plan for the asset, from evaluation data for evaluating the asset owner and the asset owned by the asset owner, reads a score threshold for the evaluation index, determined according to the evaluation index, from policy data for determining an evaluation policy of an asset owner for each consignor, extracts an asset owner satisfying the read score threshold, and outputs the operation plan for the asset used by the consignor based on asset data indicating a state of an asset.

### TECHNICAL FIELD

The present invention relates to an information management system and an information management method.

### BACKGROUND ART

A vehicle management device and an information processing device for making an operation plan in consideration of a state of an electric vehicle (EV) or the like have been proposed. A device disclosed in PTL 1 makes an operation plan for a vehicle with high accuracy in a plurality of districts according to an external variation factor such as a deterioration state of a battery of an EV vehicle and season information and weather information related to the plurality of districts. A device disclosed in PTL 2 collects infrastructure information in real time, calculates an evaluation value related to a plurality of evaluation indices based on the collected information, compares the evaluation values, and makes an operation plan according to a parameter such as a priority.

### CITATION LIST

### Patent Literature

PTL 1: JP2021-86570A
PTL 2: JP2016-149168A

### SUMMARY OF INVENTION

### Technical Problem

In recent years, in a logistics business, introduction of an EV vehicle is advanced in order to achieve low-carbon logistics as a part of efforts to achieve sustainable development goals (SDGs). However, in a business model in which an asset such as an EV vehicle or an EV station serving as a charging facility for an EV vehicle is owned by a logistics business operator (consignor), costs are high due to problems such as maintenance and battery life of an EV vehicle. Therefore, attention is focused on a business model in which a consignor utilizes a plurality of businesses that own assets (asset owners) (4PL: 4th party logistics). In such a business model, it is required to aggregate a plurality of asset owners and asset states in real time and perform asset operation planning for a plurality of consignors. In order to achieve low-carbon logistics, each consignor needs to make an operation plan in consideration of various concerns, such as giving priority to an asset owner who contributes to energy conservation, or avoiding the use of an asset owner whose driver overworks because the driver is considered to be at high risk of causing accidents. However, when considering an actual operation, it is desirable to set the concerns as simply as possible.

In the related art, there is a technique for making an operation plan for an EV vehicle for business use in consideration of a state of a vehicle, a charging time, a position of a charging base, and the like. In PTL 1, a highly accurate vehicle deployment plan is generated by taking into consideration an external variation factor such as season and environment and an influence of a deterioration state of a battery of an EV vehicle on a traveling distance or a traveling time of the vehicle. However, in the case of a business model such as 4PL, information related to an asset owner is not taken into consideration, and the above technique is not sufficient for making an operation plan.

In addition, there is an information processing technique related to an operation of a social infrastructure as a technique in which a target area of an operation plan is expanded. In PTL 2, a plurality of pieces of infrastructure information are collected in real time, an evaluation value related to a plurality of evaluation indices is calculated based on the collected information, the evaluation values are compared, and an operation plan is made according to a parameter such as a priority. Therefore, it is possible to replace with a technique that evaluates a plurality of asset owners of a 4PL business model using the plurality of evaluation indices. However, in an EV operation plan, it is necessary to perform evaluation in consideration of various different concerns of many consignors, and it is desirable to simplify the setting in consideration of an actual operation. Here, it is possible to collectively evaluate a plurality of concerns into categories such as ESG scores (E: Environmental, S: Social, G: Governance), and PTL 2 discloses “calculation of an operation plan according to a parameter such as a priority” but does not disclose a method for determining the calculation, which makes the operation complicated when there are many evaluation indices. In an EV operation plan, even when an evaluation value of an asset owner is high, when an asset of the asset owner is substantially in a use state, the asset cannot be included in the operation planning. On the other hand, in order to perform an operation, it is necessary to relatively evaluate a range of assets for which an operation plan can be made in a current asset use status, and dynamically determine an allowable range for a consignor. The above technique does not describe how a real-time situation is taken into consideration in calculation of an operation plan, and is not sufficient for operation planning.

In view of the above problems, an object of the invention is to provide an information management system and a method for planning an optimum asset operation in consideration of a use status of an asset and various concerns of consignors on a plurality of asset owners with a simple procedure.

### Solution to Problem

In information management system according the invention for supporting construction of an operation plan related to delivery of a cargo by using a computer including a processor and a memory, the processor is configured to extract an asset that is usable by a consignor from use status data indicating use status of assets of one or more asset owners that are used for delivering a cargo by an electric vehicle (EV), based on the use status data and a delivery specification of a cargo to be delivered for the consignor, read, for an asset owner of the extracted usable asset, an evaluation index of a concern that is important to the consignor when making an operation plan for the asset from evaluation data for evaluating the asset owner and the asset owned by the asset owner, read a score threshold for the evaluation index, which is determined according to a weight of the evaluation index, from policy data for determining an evaluation policy of an asset owner for each consignor, extract an asset owner satisfying the read score threshold from the extracted use status data, and output the operation plan for the asset to be used by the consignor based on asset data indicating a state of an asset owned by the extracted asset owner.

### Advantageous Effects of Invention

According to the invention, an optimum asset operation plan can be made in consideration of use status of an asset and various concerns of a consignor on a plurality of asset owners with a simple procedure.

### BRIEF DESCRIPTION OF DRAWINGS

FIG. 1 is a flowchart showing an information management method according to an embodiment.

FIG. 2A is a configuration diagram showing an information management system according to the present embodiment.

FIG. 2B is a schematic diagram showing a computer according to the present embodiment.

FIG. 3 is a diagram showing an example of a policy storage unit according to the present embodiment.

FIG. 4 is a diagram showing an example of an asset use status storage unit according to the present embodiment.

FIG. 5 is a diagram showing an example of an asset collection data storage unit according to the present embodiment.

FIG. 6 is a diagram showing an example of a score storage unit according to the present embodiment.

FIG. 7 is a diagram showing an example of an evaluation data storage unit according to the present embodiment.

FIG. 8 is a diagram showing an example of a score history storage unit according to the present embodiment.

FIG. 9 is a configuration diagram showing an example of policy update unit according to the present embodiment.

FIG. 10 is a configuration diagram showing an example of an asset extraction unit according to the present embodiment.

FIG. 11 is a configuration diagram showing an example of a score evaluation unit according to the present embodiment.

FIG. 12 is a configuration diagram showing an example of a score reference recommendation unit according to the present embodiment.

FIG. 13 is a configuration diagram showing an example of an improvement estimation unit according to the present embodiment.

FIG. 14 is a flowchart showing improvement estimation in the information management method according to the present embodiment.

FIG. 15 shows an example of a screen output for recommending a score reference and setting a threshold according to the present embodiment.

FIG. 16 shows an example of a screen output for estimating an improvement pattern of ESG scores and the number of orders expected based on the improvement pattern according to the present embodiment.

FIG. 17 is a diagram showing an example in which the information: management system according to the present embodiment is applied to a logistics business.

### DESCRIPTION OF EMBODIMENTS

Hereinafter, an embodiment according to the invention will be described with reference to the drawings. The following description and drawings are examples for showing the invention, and are appropriately omitted and simplified for clarity of the description. The invention can be implemented in various other forms. Unless otherwise specified, each component may be single or plural.

In order to facilitate understanding of the invention, a position, size, shape, range, and the like of each component shown in the drawings may not represent an actual position, size, shape, range, and the like. Therefore, the invention is not necessarily limited to the position, size, shape, range, or the like disclosed in the drawings.

In the following description, various types of information may be described using expressions such as “database”, “table”, and “list”, but the various types of information may be expressed by other data structures. In order to indicate that information does not depend on a data structure, “XX table”, “XX list”, and the like may be referred to as “XX information”. In description of identification information, when expressions such as “identification information”, “identifier”, “name”, “ID”, and “number” are used, the expressions can be replaced with one another.

When there are a plurality of components having the same or similar functions, the plurality of components may be denoted by the same reference numerals added with different subscripts. However, when it is not necessary to distinguish the plurality of components, the plurality of components may be described in a manner of omitting the subscripts.

In addition, in the following description, processing may be described by executing a program, and the program may be executed by a processor (for example, a CPU or a graphics processing unit (GPU)), thereby executing predetermined processing using a storage resource (for example, a memory) and/or an interface device (for example, a communication port) as appropriate. Therefore, a subject of the processing may be the processor. Similarly, the subject of the processing executed by executing a program may be a controller, a device, a system, a computer, or a node including a processor. The subject of the processing executed by executing a program may be a calculation unit, and may include a dedicated circuit (for example, a field-programmable gate array (FPGA) or an application specific integrated circuit (ASIC)) that executes specific processing.

The program may be installed on a device such as a computer from a program source. The program source may be, for example, a program distribution server or a computer-readable storage medium. When the program source is the program distribution server, the program distribution server may include a processor and a storage resource for storing a program to be distributed, and the processor of the program distribution server may distribute the program to be distributed to another computer. In the following description, two or more programs may be implemented as one program, or one program may be implemented as two or more programs.

Hereinafter, embodiments of the invention will be described in detail with reference to the drawings.

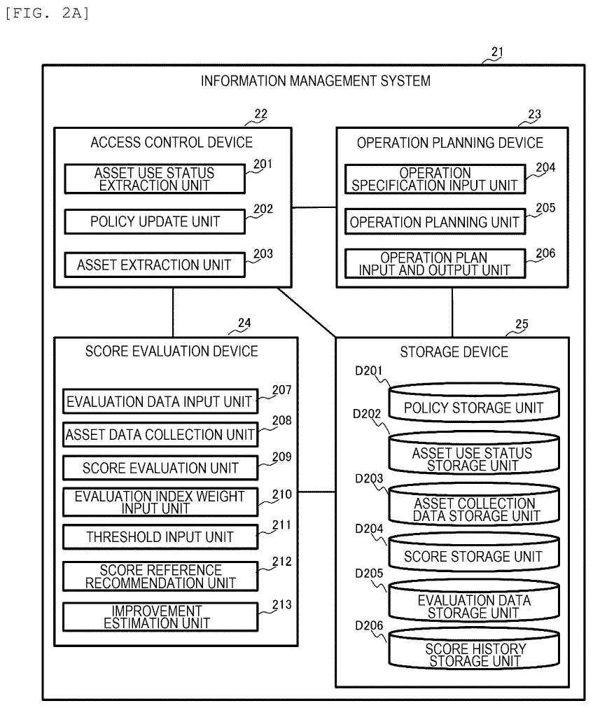

FIG. 2A is an information management system when the invention is applied to a logistics business. An information management system 21 shown in FIG. 2A includes an access control device 22, an operation planning device 23, a score evaluation device 24, and a storage device 25. The access control device 22 includes an asset use status extraction unit 201, a policy update unit 202, and an asset extraction unit 203. The operation planning device 23 includes an operation specification input unit 204, an operation planning unit 205, and an operation plan input and output unit 206. The score evaluation device 24 includes an evaluation data input unit 207, an asset data collection unit 208, a score evaluation unit 209, an evaluation index weight input unit 210, a threshold input unit 211, a score reference recommendation unit 212, and an improvement estimation unit 213. The storage device 25 includes a policy storage unit D201, an asset use status storage unit D202, an asset collection data storage unit D203, a score storage unit D204, an evaluation data storage unit D205, and a score history storage unit D206.

The access control device 22, the operation planning device 23, and the score evaluation device 24 provided in the information management system 21 can be implemented by, for example, a general computer 9201 including a CPU 9202, a memory 9203, an external storage device 9204 such as a hard disk drive (HDD), an external medium output device 9207 that reads and writes information to and from a portable storage medium, such as a compact disk (CD) or a USB memory, an input device 9206 such as a keyboard or a mouse, an output device 9205 such as a display, and a network communication device 9208 such as a network interface card (NIC) for connecting to a communication network N, as shown in FIG. 2B (schematic diagram showing a computer). In FIG. 2A, the external storage device 9204 is connected to each device via a communication network as the storage device 25.

Various kinds of data stored in the system or used for processing can be obtained by the CPU 9202 reading and using the data from the memory 9203 or the external storage device 9204. Further, each functional unit (for example, the asset use status extraction unit 201, the policy update unit 202, the asset extraction unit 203, the operation specification input unit 204, the operation planning unit 205, the operation plan input and output unit 206, the evaluation data input unit 207, the asset data collection unit 208, the score evaluation unit 209, the evaluation index weight input unit 210, the threshold input unit 211, the score reference recommendation unit 212, and the improvement estimation unit 213) provided in the system can be implemented by the CPU 9202 loading a predetermined program stored in the external storage device 9204 into the memory 9203 and executing the program.

The above-described predetermined program may be stored (downloaded) in the external storage device 9204 from a storage medium via the external medium output device 9207 or from a network via the network communication device 9208, and then loaded into the memory 9203 and executed by the CPU 9202. Alternatively, the program may be directly loaded from the storage medium into the memory 9203 via the external medium output device 9207 or from the network via the network communication device 9208, and executed by the CPU 9202.

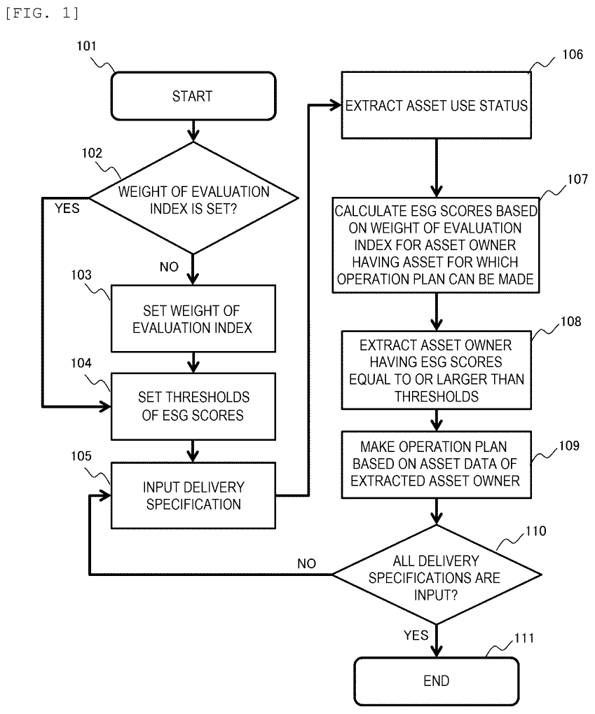

A series of processing procedures for making an operation plan will be described with reference to FIG. 1.

FIG. 1 is a flowchart showing an example of a processing procedure in the information management system shown in FIGS. 2 to 17. An operation based on this flowchart is described as below.

Step 101: The score evaluation device 24 starts the processing at a predetermined timing.

Step 102: The score evaluation device 24 determines whether a weight of an evaluation index is set by the evaluation index weight input unit 210. When the weight of the evaluation index is not set, the processing proceeds to step 103 (step 102; NO), and when the weight of the evaluation index is already set, the processing proceeds to step 104 (step 102; YES).

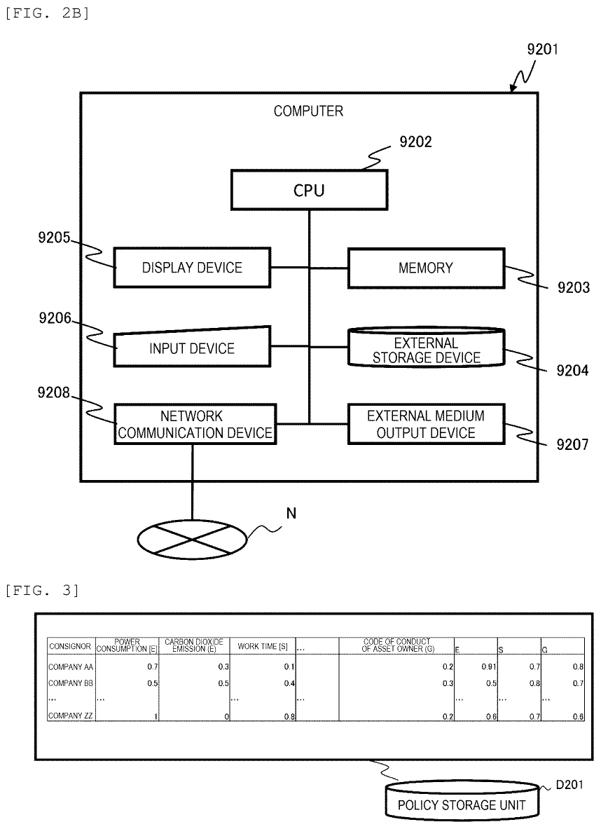

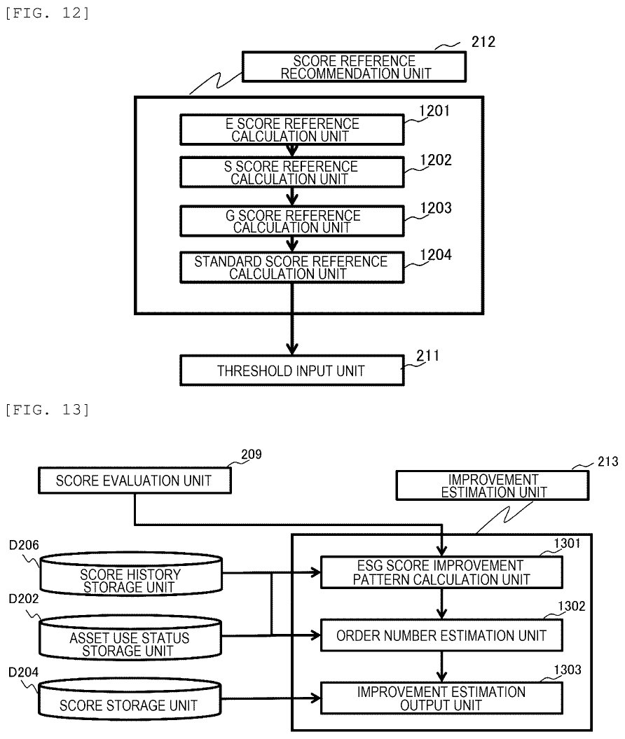

Step 103: The score evaluation device 24 causes the evaluation index weight input unit 210 to input the weight of the evaluation index for various concerns about an asset owner that are important to a consignor when making an operation plan, and causes the policy update unit 202 of the access control device 22 to store the weight of the evaluation index in the policy storage unit D201 as a policy for asset owner evaluation (FIG. 3). Details of the processing will be described later with reference to FIG. 9. An asset is a resource used to deliver a cargo by an EV, and includes various hardware resources including the EV and a charging station, and software resources. An asset owner is a business entity such as a company or an organization who owns, maintains, and manages these assets.

Step 104: The score evaluation device 24 causes the threshold input unit 211 to input thresholds of ESG scores related to the asset owner when an operation plan is made, and causes the policy update unit 202 of the access control device 22 to store the threshold in the policy storage unit D201 as a policy for asset data extraction (FIG. 3). Details of the processing will be described later with reference to FIG. 9.

Step 105: The operation planning device 23 causes the operation specification input unit 204 to input a specification related to delivery for a consignor.

Step 106: The access control device 22 causes the asset use status extraction unit 201 to extract asset use status from the asset use status storage unit D202 and extract an asset owner having a usable asset (FIG. 4). Details of the processing will be described later with reference to FIG. 10.

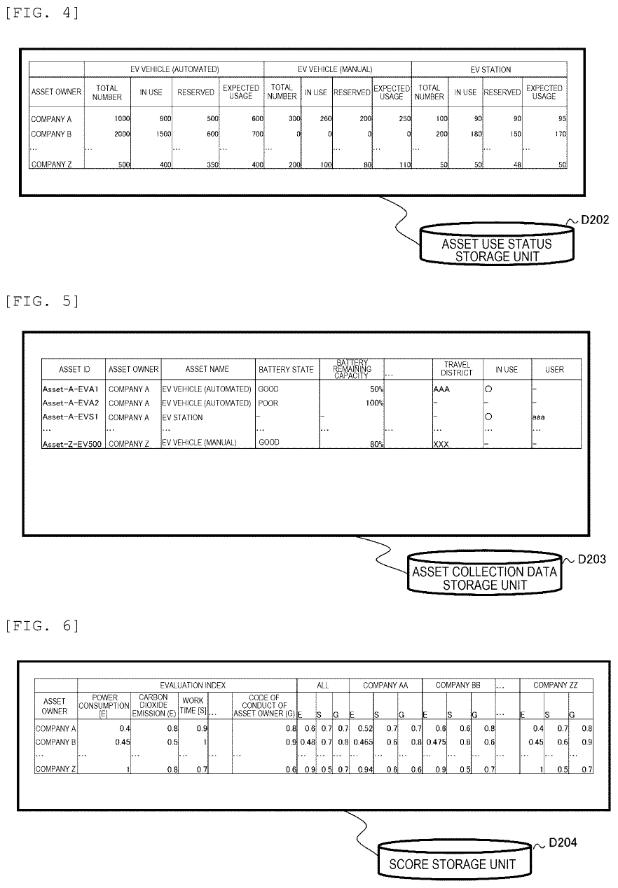

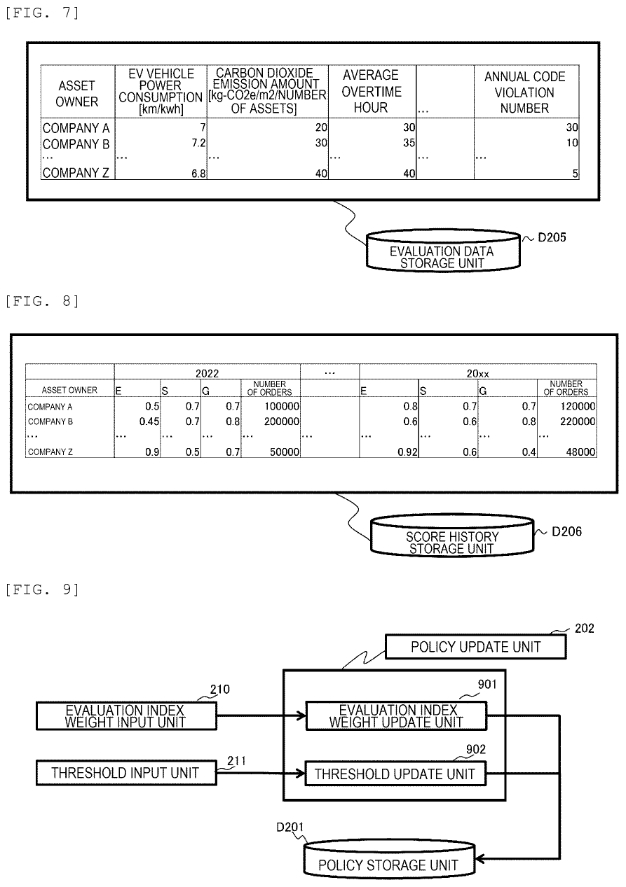

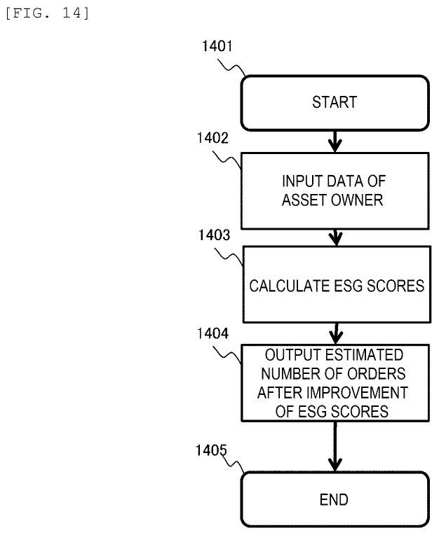

Step 107: The score evaluation device 24 causes the score evaluation unit 209 to calculate ESG scores for asset owners extracted in step 106 by using a numerical value of an evaluation index stored in the evaluation data storage unit D205 based on the weight of the evaluation index input in step 103, and stores the calculated ESG scores in the score storage unit D204 (FIGS. 6 and 7). Details of the processing will be described later with reference to FIGS. 10 and 11.

Step 108: The access control device 203 causes the asset extraction unit 203 to extract an asset owner having ESG scores that satisfy the thresholds based on the ESG scores calculated in step 107 and the thresholds input in step 104. Details of the processing will be described later with reference to FIG. 10.

Step 109: The operation planning device 23 causes the operation planning unit 205 to make an asset operation plan for the asset owner that has ESG scores satisfying the thresholds and is extracted in Step 108. Further, the operation plan input and output 205 outputs the asset operation plan, allows a consignor to determine an operation plan, and stores asset use status based on determined content in the asset use status storage unit D202. Details of the processing will be described later with reference to FIG. 10.

Step 110: The operation planning device 23 causes the operation specification input unit 204 to determine whether all delivery specifications are input and determine whether the input of all delivery specifications is completed. When the input of all delivery specifications is not completed, the processing returns to step 105 (step 110; NO), and when the input of all delivery specifications is completed, the processing ends (step 110; YES, step 111).

The information management system shown in FIG. 2A is implemented by the following configuration.

The evaluation index weight input unit 210 inputs a weight of an evaluation index according to concerns of a consignor. The weight of the evaluation index may be input each time, or once the weight of the evaluation index is input, the weight of the evaluation index does not need to be input each time.

The threshold input unit 211 inputs thresholds of ESG scores to be satisfied by an asset owner when making an operation plan.

The policy update unit 202 updates the weight of the evaluation index and the thresholds.

FIG. 9 is a configuration diagram showing an example of the policy update unit according to the present embodiment. The policy update unit 202 includes an evaluation index weight update unit 901 and a threshold update unit 902.

The evaluation index weight update unit 901 stores the weight of the evaluation index input from the evaluation index weight input unit 210 in the policy storage unit D201. The threshold update unit 902 stores the thresholds of ESG scores input from the threshold input unit 211 in the policy storage unit D201.

FIG. 3 is a diagram showing an example of the policy storage unit according to the present embodiment. As shown in FIG. 3, for each consignor, the weight of the evaluation index and the thresholds of the ESG scores are stored according to concerns about an asset owner. The above-described concerns are various concerns about an asset owner that are important to a consignor when making an operation plan, and is, for example, a point of view of a consignor that is considered important for long-term growth of a company in order to realize a sustainable society, such as environmental (E), social(S), and governance (G). According to the scores (ESG scores) based on this point of view, it is possible to quantitatively measure and relatively compare performance and risk of an asset owner which is a company to be evaluated. For example, for E of the ESG scores, in a case where evaluation is performed based on power consumption of an asset and a carbon dioxide emission amount related to a facility of an asset owner, when a consignor AA places more importance on the power consumption of an asset than the carbon dioxide emission amount related to a facility of an asset owner, a weight for the power consumption is stored as 0.7 and a weight for the carbon dioxide emission amount is stored as 0.3 so that a total weight for E is 1. Since an importance level is different for each score of the ESG scores, a value of 0 to 1 is input to each of the ESG scores and is stored as a threshold. In the present example, for the consignor AA, 0.91 for E, 0.7 for S, and 0.8 for G are input as the respective thresholds of the ESG scores.

The operation specification input unit 204 inputs a delivery specification such as a weight of a cargo to be delivered and pickup and drop-off destinations.

The asset use status extraction unit 201 extracts an asset owner having a usable asset from the asset use status storage unit D202. In the extraction of an asset owner having a usable asset, an asset owner whose asset amount can be ensured by a minimum asset amount which is empirically required for making an operation plan may be extracted based on asset use status, or an asset owner whose minimum required asset amount can be determined and for which the asset amount can be ensured may be extracted based on a regression model in which a delivery specification such as a cargo amount is used as a description variable. The regression model may be created for each consignor. Further, when an asset amount that can be ensured by a certain asset owner is insufficient as compared with a minimum required asset amount, a combination of a plurality of asset owners may be handled as a new asset owner. In this case, a numerical value of an evaluation index stored in the score storage unit D204 described later is a value calculated using the asset amount as a weight.

FIG. 4 is a diagram showing an example of the asset use status storage unit according to the present embodiment. As shown in FIG. 4, information on a total number of assets, use status (in use), reservation status (reserved), and expected usage is stored for each asset owner. For example, a company A has 1000 EV vehicles (automated driving), of which 800 assets are in use, 500 assets are reserved, and 600 assets are expected to be used in the future. The expected usage may be derived by calculating an expected usage number over a few days or weeks in the future by averaging the usage number over a few days or weeks in the past, or may be derived by constructing a prediction model from time-series data of asset usage. When the prediction model is constructed, the prediction model is incorporated into the asset data collection unit 208. There are many well-known techniques for constructing the prediction model, such as machine learning related to time series prediction. Please refer to relevant textbooks.

The asset data collection unit 208 collects, in real time, information related to all assets connected to the information management system, and stores the collected information in the asset use status storage unit D202 and the asset collection data storage unit D203.

FIG. 5 is a diagram showing an example of the asset collection data storage unit according to the present embodiment. As shown in FIG. 5, information such as an asset owner name, an asset name, a battery state or a battery remaining capacity in the case of an EV vehicle, a travel district, whether the asset is being used, and a user is stored for each asset. These kinds of information are used for operation planning in the operation planning unit 205.

FIG. 6 is a diagram showing an example of the score storage unit according to the present embodiment. As shown in FIG. 6, for each asset owner, a numerical value of an evaluation index of 0 to 1 stored, and ESG scores evaluated for all asset owners and ESG scores evaluated based on an evaluation index weight of each consignor are stored. In the present example, for an asset owner of a company A, numerical values of evaluation indices such as power consumption (E), carbon dioxide emission (E), work time(S), . . . , and a code of conduction of an asset owner (G) are respectively calculated as “0.4”, “0.8”, “0.9”, and “0.8”. In addition, for the asset owner of the company A, the ESG scores evaluated for all asset owners are respectively calculated as “0.6”, “0.7”, and “0.7”, and the ESG scores evaluated based on the evaluation index weight of each consignor are respectively calculated as “0.52”, “0.7”, and “0.7” in a case where a consignor is a company AA. In the ESG scores evaluated for all asset owners, equally divided evaluation index weights may be used, or an evaluation index weight that is empirically set based on a tendency valued by each consignor may be used.

The score evaluation unit 209 normalizes a numerical value of each evaluation index and calculates the ESG scores based on a weight of the evaluation index.

FIG. 11 is a configuration diagram showing an example of the score evaluation unit according to the present embodiment. The score evaluation unit 209 includes an evaluation data extraction unit 1101, an E score calculation unit 1102, an S score calculation unit 1103, and a G score calculation unit 1104.

The evaluation data extraction unit 1101 starts extraction of evaluation data from the evaluation data storage unit D205 in response to a data input by the evaluation data input unit 207. In addition to the data input by the evaluation data input unit 207, the evaluation data extraction unit 1101 also starts extraction by the policy extraction unit 1002. When the extraction by the policy extraction unit 1002 is started, evaluation data is extracted from among asset owners received from the policy extraction unit 1002.

The E score calculation unit 1102 calculates an E score obtained by aggregating evaluation indices related to environmental, and stores the E score in the score storage unit D204. When evaluation is performed for all asset owners in the calculation of the E score, the score is also stored in the score history storage unit D206. In the calculation of the E score, a numerical value of an evaluation index is normalized, and when the evaluation is performed for all asset owners, equally divided evaluation index weights are used or an evaluation index weight that is empirically set based on a tendency valued by each consignor is used to calculate a weighted average. Alternatively, when the extraction by the policy extraction unit 1102 is started, the weighted average is calculated using an evaluation index weight from the policy extraction unit 1102.

The S score calculation unit 1103 calculates an S score obtained by aggregating evaluation indices related to social and stores the S score in the score storage unit D204. When evaluation is performed for all asset owners in the calculation of the S score, the score is also stored in the score history storage unit D206. Similar to the E score calculation unit 1102, the aggregation of the evaluation indices is performed by normalizing a numerical value of an evaluation index and then calculating a weighted average.

The G score calculation unit 1104 calculates a G score obtained by aggregating evaluation indices related to governance, and stores the G score in the score storage unit D204. When evaluation is performed for all asset owners in the calculation of the G score, the score is also stored in the score history storage unit D206. Similar to the E score calculation unit 1102, the aggregation of the evaluation indices is performed by normalizing a numerical value of an evaluation index and then calculating a weighted average.

FIG. 7 is a diagram showing an example of the evaluation data storage unit according to the present embodiment. As shown in FIG. 7, information related to an asset such as EV vehicle power consumption, and information related to an asset owner such as a carbon dioxide emission amount, an average overtime hour, and the number of violation of a code such as a traffic rule are stored for each asset owner. Data stored in the evaluation data storage unit D205 is stored when an asset owner is registered in the system. As shown in FIG. 7, for example, a company A is an asset owner having EV vehicle power consumption of 7 [km/kwh], a carbon dioxide emission amount of 20 [kg-CO2e/m2/number of assets], an overtime hour of 30 hours, and an annual code violation number of 30.

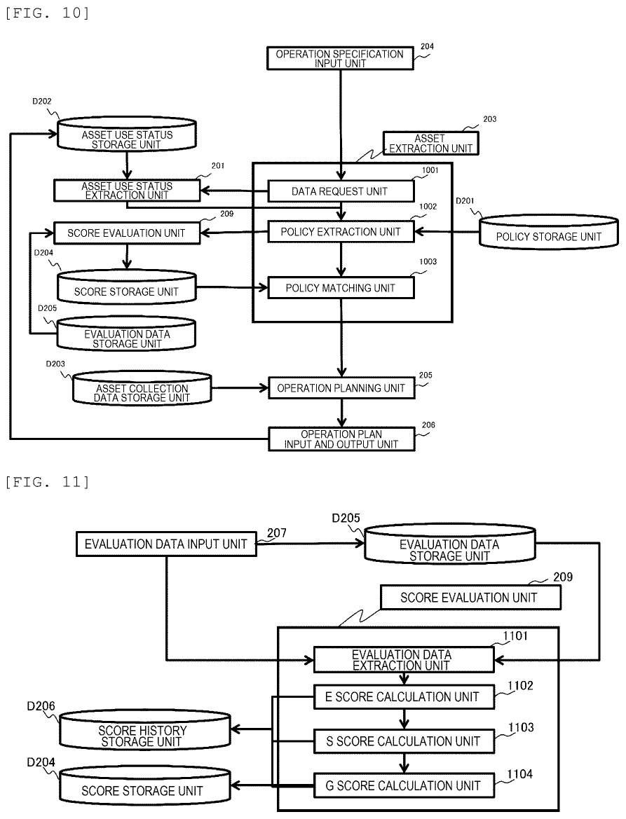

FIG. 8 is a diagram showing an example of the score history storage unit according to the present embodiment. As shown in FIG. 8, the ESG scores and the number of orders are stored in units of one year for each asset owner. ESG scores are stored as values evaluated for all asset owners. Since the ESG scores rarely fluctuate greatly over a period of a few days or weeks, the ESG scores are stored in units of one year. Alternatively, the ESG scores may be stored in units of a few months or years. In FIG. 8, for example, the ESG scores of a company A in the year 2022 are respectively “0.5”, “0.7”, and “0.7”, and the number of orders of an asset (for example, a charging station) is “100000”. The number of orders of an asset is set, for example, in another system such as a sales system managed by an asset owner, or is calculated based on the number of assets that is “in use” and stored in the asset use status storage unit D202.

The asset extraction unit 203 narrows down asset owners according to a threshold of a consignor.

FIG. 10 is a configuration diagram showing an example of the asset extraction unit according to the present embodiment. The asset extraction unit 203 includes a data request unit 1001, a policy extraction unit 1002, and a policy matching unit 1003.

When a delivery specification of a consignor is input by the operation specification input unit 204, the data request unit 1001 requests extraction of a usable asset and extraction of a policy.

The policy extraction unit 1002 extracts, from the policy storage unit D201, an evaluation index weight and a threshold related to a consignor whose delivery specification is input by the data request unit 1001. Further, the score evaluation unit 209 is requested to evaluate ESG scores of an asset owner extracted by the asset use status extraction unit 201.

The policy matching unit 1003 compares a threshold extracted by the policy extraction unit 1002 with the ESG scores extracted from the score storage unit D204, and extracts an asset owner having ESG scores equal to or larger than the threshold.

In the operation planning unit 205, an operation plan is made with the narrowed asset owners, a result is output to the operation plan input and output unit 206, and a result of asset usage according to the determined operation plan is stored in the asset use status storage unit D202. When making an operation plan, for example, in the case of operating an EV vehicle, it is possible to make an operation plan in which an asset having an ID of Asset-A-EVA1 is excluded from an operation target since the asset is in use, an asset having an ID of Asset-A-EVA2 is not in use and a battery remaining capacity is 100%, but a battery state of the asset is poor and is not suitable for long-distance traveling, so that the asset having an ID of Asset-A-EVA2 is excluded from an operation target, and an asset having an ID of Asset-Z-EV500 is operated since the asset is not in use, a battery remaining capacity is sufficient as 80%, and a battery state is good. Various optimization methods can be used when making an operation plan, and for example, a plurality of objects such as a battery deterioration state and power consumption may be set based on conditions such as a delivery destination included in a delivery specification, and an evolution algorithm or the like may be used to derive a Pareto solution. There are many well-known optimization techniques, and please refer to relevant textbooks.

FIG. 12 is a configuration diagram showing an example of the score reference recommendation unit according to the present embodiment. The score reference recommendation unit 212 includes an E score reference calculation unit 1201, an S score reference calculation unit 1202, a G score reference calculation unit 1203, and a standard score reference calculation unit 1204.

The E score reference calculation unit 1201 calculates a threshold reference value for an E score obtained by aggregating evaluation indices related to environmental, so that an operation plan can be made. In order to make an operation plan, a reference value that can ensure an asset amount may be calculated based on a minimum asset amount that is required for an operation plan according to experience, or a reference value that can ensure an asset amount may be calculated by determining a minimum required asset amount based on a regression model in which a delivery specification such as a cargo amount is used as description variable. The regression model may be created for each consignor.

The S score reference calculation unit 1202 calculates a threshold reference value for an S score obtained by aggregating evaluation indices related to social, so that an operation plan can be made according to the same method as that of the E score reference calculation unit 1201.

The G score reference calculation unit 1203 calculates a threshold reference value for a G score obtained by aggregating evaluation indices related to Governance, so that an operation plan can be made according to the same method as that of the E score reference calculation unit 1201.

In order to take into consideration all scores, the standard score reference calculation unit 1204 standardizes E, S, and G scores, and calculates a threshold reference value for a score obtained by adding the standardized scores, so that an operation plan can be made according to the same method as that of the E score reference calculation unit 1201. Each calculated reference value is a reference value in the threshold input unit 211.

FIG. 15 is a diagram showing an example of a screen displayed by the threshold input unit 211 according to the present embodiment. As shown in FIG. 15, the threshold input unit 211 can receive setting of a threshold of each of the E, S, and G scores from a user. The threshold input unit 211 displays an inverse cumulative distribution for each of the E, S, and G scores, in which a vertical axis indicates a ratio of an asset owner that satisfies a score to all asset owners and a horizontal axis indicates each of the E, S, and G scores. The user can confirm the number of asset owners corresponding to the set threshold. For example, when the threshold input unit 211 receives a slide operation in an up-down direction of a button (buttons 1501, 1502, 1503) for setting a threshold of each of the E, S, and G scores from the user, positions of reference lines 1504, 1505, and 1506 displayed in association with the thresholds in the inverse cumulative distribution are moved in conjunction with the slide operation. At this time, the threshold input unit 211 displays ratios (the number of persons) of asset owners corresponding to positions of the moved reference lines 1504, 1505, and 1506. In the present example, the number of asset owners satisfying the thresholds is respectively a, B, and Y. According to the thresholds, the threshold input unit 211 outputs the number of asset owners (Y persons) that satisfy the thresholds from all asset owners (XXX persons). Further, a reference value calculated by the score reference recommendation unit 212 can be set as a threshold of each of the E, S, and G scores based on selection of a radio button.

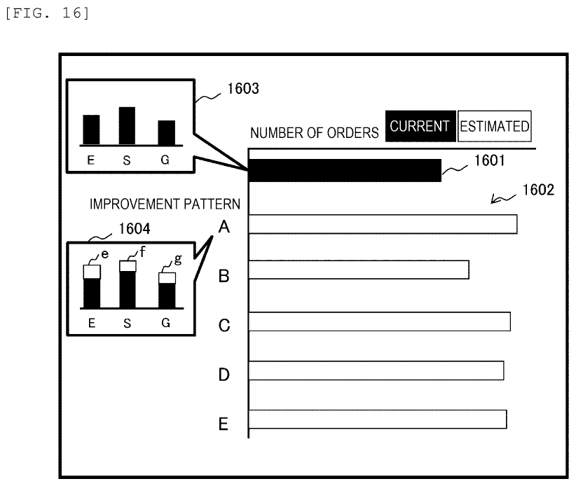

Next, an asset data input executed by the information management system according to the present embodiment configured as described above and a series of processing procedures for performing improvement estimation based on the input will be described with reference to the flowchart shown in FIG. 14. An operation based on this flowchart is described as below.

Step 1401: The score evaluation device 24 starts the present processing at a predetermined timing.

Step 1402: The score evaluation device 24 causes the evaluation data input unit 207 to input information related to an asset owner and an asset (FIG. 7), and stores the information in the evaluation data storage unit D205.

Step 1403: The score evaluation device 24 causes the score evaluation unit 209 to calculate ESG scores, and stores the ESG scores in the score storage unit D204 (FIG. 11).

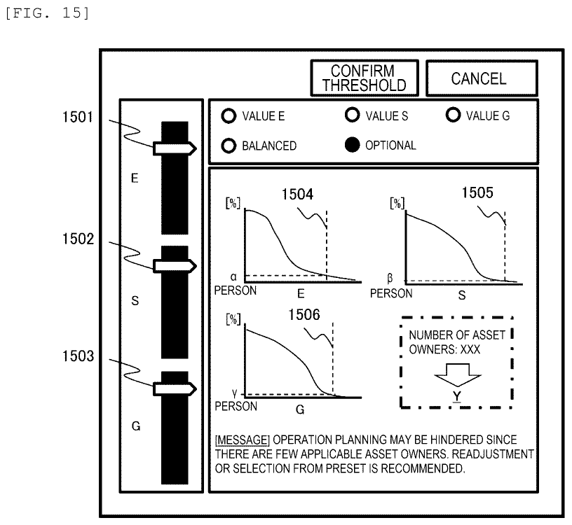

Step 1404: The score evaluation device 24 causes the improvement estimation unit 213 to estimate the number of orders expected for an asset owner after improvement of the ESG scores, and outputs estimated contents. Details of the processing will be described later with reference to FIG. 13.

The evaluation data input unit 207 receives an asset provided by the asset owner and evaluation data related to the asset owner, and stores the information in the evaluation data storage unit D205.

The improvement estimation unit 213 extracts an ESG score improvement pattern, estimates the number of orders for each improvement pattern, and outputs a result.

FIG. 13 is a configuration diagram showing an example of the improvement estimation unit according to the present embodiment. The improvement estimation unit 213 includes an ESG score improvement pattern calculation unit 1301, an order number estimation unit 1302, and an improvement estimation output unit 1303.

The ESG score improvement pattern calculation unit 1301 calculates an ESG score improvement pattern based on the ESG scores calculated by the score evaluation unit 209 and an ESG score transition history stored in the score history storage unit D206. In the calculation of the improvement pattern, when a plurality of other asset owners have past ESG scores that are close to a certain extent or more of the ESG scores calculated by the score evaluation unit 209 and the ESG scores are improved, a transition amount of the ESG scores is referenced to calculate improved ESG scores. In the calculation of the improvement pattern, a plurality of improvement patterns may be prepared in advance, and a plurality of improved ESG scores may be calculated based on a current evaluation value of an asset owner.

The order number estimation unit 1302 estimates the number of orders expected based on the improved ESG scores calculated by the ESG score improvement pattern calculation unit 1301 and the number of orders expected for current ESG scores. In the estimation of the number of orders, the number of orders is estimated based on the number of orders and an asset amount of an asset owner that is a reference source of an ESG score transition amount in the ESG score improvement pattern calculation unit 1301 and an asset amount of an asset owner that is to be estimated this time. In this case, a regression model may be created with the ESG score transition amount, the number of orders, or the asset amount as description variables, or the calculation may be performed by multiplying the number of orders of the asset owner that is the reference source of the ESG score transition amount by a ratio of the asset amount of the asset owner that is the reference source to the asset amount of the asset owner that is to be estimated this time.

The improvement estimation output unit 1303 outputs the improved ESG scores calculated by the ESG score improvement pattern calculation unit 1301 and the number of orders calculated by the order number estimation unit 1302 as an improvement pattern.

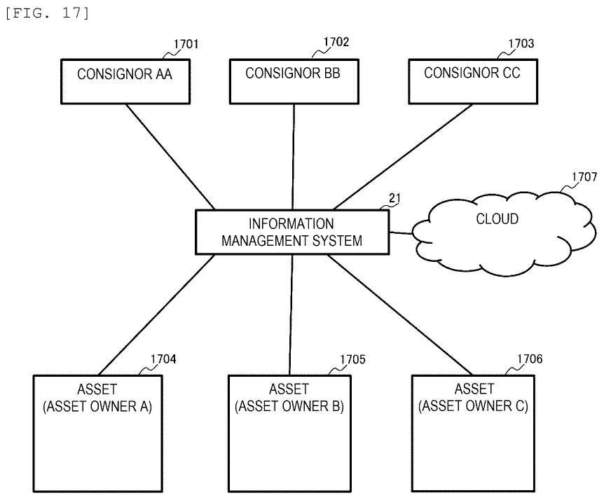

FIG. 16 is a diagram showing an example of a screen displayed by the improvement estimation unit 213 according to the present embodiment. As shown in FIG. 16, the improved ESG scores calculated by the ESG score improvement pattern calculation unit 1301 and the number of orders calculated by the order number estimation unit 1302 are used to display graphs of expected number of orders for current ESG scores and ESG scores during multiple improvement times. In FIG. 16, for example, the improvement estimation unit 213 displays, on a screen, a graph 1601 indicating the current number of orders and a graph 1602 indicating the estimated number of orders calculated by the order number estimation unit 1302. Further, when selection of the graphs 1601 and 1602 is received from a user, the improvement estimation unit 213 displays ESG scores corresponding to each graph. In FIG. 16, an ESG score 1603 corresponding to the graph 1601 and an ESG score 1604 corresponding to the graph 1602 are displayed. The improvement estimation unit 213 outputs the ESG score 1604 in a mode in which differences from the current ESG scores are visible. In the present example, differences e, f, and g between values of the current ESG scores and values of the estimated ESG scores are displayed.

FIG. 17 is a diagram showing an example in which the information management system according to the present embodiment is applied to a logistics business. As shown in FIG. 17, the information management system 21 is a system that is used by a plurality of consignors and a plurality of asset owners, and is implemented in a cloud 1707. Although consignors 1701, 1702, and 1703 are shown as examples of a consignor, more consignors may be included, and although asset owners 1704, 1705, and 1706 are shown as examples of an asset owner, more asset owners may be included.

As described above with reference to the drawings, the information management system according to the present embodiment is the information management system 21 for supporting construction of an operation plan related to delivery of a cargo by using a computer including a processor and a memory. The processor is configured to extract an asset that is usable by a consignor from use status data (data in the asset use status storage unit D202) indicating use status of assets of one or more asset owners that are used for delivering a cargo by an EV, based on the use status data and a delivery specification (data input from the operation specification input unit 204) of a cargo to be delivered for the consignor, read, for an asset owner of the extracted usable asset, an evaluation index (for example, EV vehicle power consumption, a carbon dioxide emission amount, and an average overtime hour) for a concern that is important to the consignor when making an operation plan for the asset from evaluation data (data in the evaluation data storage unit D205) for evaluating the asset owner and the asset owned by the asset owner, read a score threshold for the evaluation index, which is determined according to a weight of the evaluation index, from policy data (data in the policy storage unit D201) for determining an evaluation policy of an asset owner for each consignor, extract an asset owner satisfying the read score threshold from the extracted use status data, and output the operation plan for the asset to be used by the consignor based on asset data (data in the asset collection data storage unit D203) indicating a state of an asset owned by the extracted asset owner. Therefore, when making an EV operation plan, the evaluation index can be calculated for a plurality of asset owners in consideration of use status of an asset such as an EV, assets can be narrowed down based on the evaluation index, and the operation plan can be made with the narrowed down assets. In other words, when making an EV operation plan, in order to enable a consignor to easily make the operation plan in consideration of various concerns on an asset owner such as an EV, evaluation indexes related to a plurality of asset owners can be calculated in consideration of asset use status, assets can be narrowed down based on the evaluation indexes, and the operation plan can be made with the narrowed down assets.

As described with reference to FIG. 11 and the like, the processor calculates a score for the evaluation index based on the evaluation index read from the evaluation data and the weight of the evaluation index. Accordingly, even when the weight of the evaluation index considered important for the consignor is changed due to a business change or the like, a score for an asset owner corresponding to the change can be calculated.

As described with reference to FIG. 13, FIG. 16, and the like, the processor accumulates, for the plurality of asset owners, score history data (data in the score history storage unit D206) in which the calculated score for the evaluation index is associated with the number of orders of the asset in a predetermined period, calculates a transition amount of a score based on a transition history of the score for the evaluation index of an asset owner who has improvement in the number of orders of the asset among asset owners having a score close to a certain extent of the score for the evaluation index of an asset owner to be estimated among the accumulated score history data, and estimates an improved number of orders of the asset for the asset owner to be estimated, based on the calculated transition amount of the score, the score for the evaluation index of the asset owner to be estimated, and the number of orders of the asset for the asset owner who has improvement in the number of orders of the asset. Accordingly, for the asset owner to be estimated, the number of orders of an own asset can be estimated while referring to a score of another asset owner having a score close to a certain extent.

As described with reference to FIG. 12, FIG. 15, and the like, the processor calculates a reference value (value obtained from an inverse cumulative distribution) of the threshold of the score based on the calculated score for the evaluation index and an asset owner that is required in the operation plan for the asset, and sets the calculated reference value as the threshold of the score. Accordingly, the threshold of the score can be set after checking the number of asset owners satisfying a desired score of a consignor.

The invention is not limited to the embodiments described above, and includes various modifications. For example, the embodiments described above have been described in detail to facilitate understanding of the invention, and the invention is not necessarily limited to those including all the configurations described above. A part of a configuration of a certain embodiment can be replaced with a configuration of another embodiment, and the configuration of another embodiment can be added to the configuration of a certain embodiment. A part of a configuration of each embodiment may be added to, deleted from, or replaced with another configuration. A part or all of the configurations, functions, processing units, processing methods, and the like described above may be implemented by hardware by, for example, designing with an integrated circuit. The above configurations, functions, and the like may be implemented by software by a processor interpreting and executing a program for implementing each function. Information such as a program, a table, and a file for implementing each function can be stored in a recording device such as a memory, a hard disk, and a solid state drive (SSD), or in a recording medium such as an IC card, an SD card, and a DVD.

### REFERENCE SIGNS LIST

201 asset use status extraction unit
202 policy update unit
203 asset extraction unit
204 operation specification input unit
205 operation planning unit
206 operation plan input and output unit
207 evaluation data input unit
208 asset data collection unit
209 score evaluation unit
210 evaluation index weight input unit
211 threshold input unit
212 score reference recommendation unit
213 improvement estimation unit
D201 policy storage unit
D202 asset use status storage unit
D203 asset collection data storage unit
D204 score storage unit
D205 evaluation data storage unit
D206 score history storage unit

1. An information management system for supporting construction of an operation plan related to delivery of a cargo by using a computer including a processor and a memory, wherein
the processor is configured to
extract an asset that is usable by a consignor from use status data indicating use status of assets of one or more asset owners that are used for delivering a cargo by an electric vehicle (EV), based on the use status data and a delivery specification of a cargo to be delivered for the consignor,
read, for an asset owner of the extracted usable asset, an evaluation index of a concern that is important to the consignor when making an operation plan for the asset, from evaluation data for evaluating the asset owner and the asset owned by the asset owner,
read a score threshold for the evaluation index, which is determined according to a weight of the evaluation index, from policy data for determining an evaluation policy of an asset owner for each consignor,
extract an asset owner satisfying the read score threshold from the extracted use status data, and
output the operation plan for the asset to be used by the consignor based on asset data indicating a state of an asset owned by the extracted asset owner.

2. The information management system according to claim 1, wherein
the processor calculates a score for the evaluation index based on the evaluation index read from the evaluation data and the weight of the evaluation index.

3. The information management system according to claim 2, wherein
the processor is configured to
accumulate, for the plurality of asset owners, score history data in which the calculated score for the evaluation index is associated with the number of orders of the asset in a predetermined period,
among the accumulated score history data, calculate a transition amount of a score based on a transition history of the score for the evaluation index of an asset owner who has improvement in the number of orders of the asset among asset owners having a score close to a certain extent of the score for the evaluation index of an asset owner to be estimated, and
estimate an improved number of orders of the asset for the asset owner to be estimated, based on the calculated transition amount of the score, the score for the evaluation index of the asset owner to be estimated, and the number of orders of the asset for the asset owner who has improvement in the number of orders of the asset.

4. The information management system according to claim 2, wherein
the processor is configured to
calculate a reference value for the score threshold based on the calculated score for the evaluation index and an asset owner that is required in the operation plan for the asset, and
set the calculated reference value as the score threshold.

5. An information management method executed by an information management system for supporting construction of an operation plan related to delivery of a cargo by using a computer including a processor and a memory, the information management method comprising:
extracting an asset that is usable by a consignor from use status data indicating use status of assets of one or more asset owners that are used for delivering a cargo by an EV, based on the use status data and a delivery specification of a cargo to be delivered for the consignor;
reading, for an asset owner of the extracted usable asset, an evaluation index of a concern that is important to the consignor when making an operation plan for the asset, from evaluation data for evaluating the asset owner and the asset owned by the asset owner;
reading a score threshold for the evaluation index, which is determined according to a weight of the evaluation index, from policy data for determining an evaluation policy of an asset owner for each consignor;
extracting an asset owner satisfying the read score threshold from the extracted use status data; and
outputting the operation plan for the asset to be used by the consignor based on asset data indicating a state of an asset owned by the extracted asset owner.

6. The information management method according to claim 5, wherein
a score for the evaluation index is calculated based on the evaluation index read from the evaluation data and the weight of the evaluation index.

7. The information management method according to claim 6, further comprising:
accumulating, for the plurality of asset owners, score history data in which the calculated score for the evaluation index is associated with the number of orders of the asset in a predetermined period;
among the accumulated score history data, calculating a transition amount of a score based on a transition history of the score for the evaluation index of an asset owner who has improvement in the number of orders of the asset among asset owners having a score close to a certain extent of the score for the evaluation index of an asset owner to be estimated; and
estimating an improved number of orders of the asset for the asset owner to be estimated, based on the calculated transition amount of the score, the score for the evaluation index of the asset owner to be estimated, and the number of orders of the asset for the asset owner who has improvement in the number of orders of the asset.

8. The information management method according to claim 6, further comprising:
calculating a reference value for the score threshold based on the calculated score for the evaluation index and an asset owner that is required in the operation plan for the asset; and
setting the calculated reference value as the score threshold.
